(19) United States
(12) Patent Application Publication
(10) Pub. No.: US 2018/0188912 A1
(43) Pub. Date: Jul. 5, 2018

(54) INFORMATION PROCESSING APPARATUS AND INFORMATION PROCESSING METHOD

(71) Applicant: YAMAHA CORPORATION, Hamamatsu-shi (JP)

(72) Inventor: Keisuke TSUKADA, Hamamatsu-shi (JP)

(21) Appl. No.: 15/911,294

(22) Filed: Mar. 5, 2018

Related U.S. Application Data
(63) Continuation of application No. PCT/JP2017/000987, filed on Jan. 13, 2017.

(30) Foreign Application Priority Data
Jan. 14, 2016 (JP) 2016-005259

(51) Int. Cl. G06F 3/0482; G06F 3/0481; G06F 3/16

(52) U.S. Cl. CPC G06F 3/0482; G06F 3/04812; H04M 1/72558; G06F 3/162; G06F 3/04817

(57) ABSTRACT

An information processing apparatus includes first-third obtaining portions, and a display controller. The first obtaining portion obtains list information of content data that is playable by an external device. The second obtaining portion obtains storage place information of corresponding image data, based on the list information. The third obtaining portion obtains the image data based on the storage place information. The display controller displays a list screen using a predetermined image on a display portion, based on the list information, and changes the predetermined image based on the image data that the third obtaining portion obtains.

### CROSS REFERENCE TO RELATED APPLICATIONS

The present application is a continuation application of International Patent Application No. PCT/JP2017/000987, filed on 13 Jan. 2017, which claims priority to Japanese Patent Application No. 2016-005259, filed on 14 Jan. 2016. The contents of these applications are incorporated herein by reference in their entirety.

### BACKGROUND OF THE INVENTION

### 1. Field of the Invention

A preferred embodiment of the present invention relates to an information processing apparatus and an information processing method that display list information with respect to content data stored in an external device.

### 2. Description of the Related Art

Japanese Unexamined Patent Application Publication No. 2007-158854 discloses a network audio system that uses a wireless LAN (Local Area Network). The audio system disclosed in Japanese Unexamined Patent Application Publication No. 2007-158854 is configured to have a storage device, a player, and the like that have stored sound data connect through the wireless LAN (or a wired LAN) and to transmit and receive the sound data.

Each device connected to the wireless LAN is operable with an information processing apparatus, such as a portable phone that a user owns. For example, sound data stored in the storage device is displayed by an icon on a display portion of an information processing apparatus, and a user, by selecting the icon, can make the sound data corresponding to a selected icon output from a player or the like.

An information processing apparatus can request to each device for list information of music that is playable by a player or the like. But devices that are able to return list information in the latest format and devices that are unable to return such list information to the information processing apparatus can coexist. Even in this state, the information processing apparatus needs to be able to control each device.

### SUMMARY OF THE INVENTION

In view of the foregoing, aspects of the present invention include an information processing apparatus and an information processing method that can display a list of content data without depending on a format of list information from an external device.

One aspect of the present invention is the information processing apparatus that can include first to third obtaining portions or tasks, and a display controller. The first obtaining portion or task is configured to obtain list information of content data that is playable by an external device. The second obtaining portion or task is configured to obtain storage place information of corresponding image data, based on the list information. The third obtaining portion or task is configured to obtain the image data based on the storage place information. The display controller is configured to display a list screen using a predetermined image on a display portion based on the list information and changes the predetermined image based on the image data that the image data obtaining portion or task obtains.

The above and other elements, features, characteristics, and advantages of the present invention will become more apparent from the following detailed description of the preferred embodiments with reference to the attached drawings.

### BRIEF DESCRIPTION OF THE DRAWINGS

FIG. 1 is a diagram illustrating a configuration of an audio system according to one embodiment.

FIG. 2 is a block diagram illustrating a configuration of a portable terminal.

FIG. 3 illustrates content data.

FIG. 4 shows a screen to be displayed on a display portion based on received list information.

FIG. 5 illustrates a display mode of the display portion in a case where list information of hierarchical data is selected.

FIG. 6A and FIG. 6B illustrate another example of a list screen to be displayed on the display portion based on the received list information.

FIG. 7 is a flow chart illustrating a process when the portable terminal displays list information.

### DETAILED DESCRIPTION

An information processing apparatus according to one embodiment according to the present invention can include a first obtaining portion or task configured to obtain list information of content data that is playable by an external device, a second obtaining portion or task configured to obtain storage place information of corresponding image data, based on the list information, a third obtaining portion or task configured to obtain the image data based on the storage place information, and a display controller configured to display a list screen using a predetermined image on a display portion based on the list information and change the predetermined image based on the image data that the third obtaining portion or task obtains.

As described above, the information processing apparatus can request to each device for list information of music that is playable by a player or the like. But devices that are able to return list information in the latest format and devices that are unable to return such list information can coexist. For example, not all devices are updated to the latest firmware that can return the latest list information. Even in this state, the information processing apparatus needs to be able to control each device.

In the above configuration, in a case of obtaining image data corresponding to obtained list information, the list information is displayed using the image data, and, in a case of not obtaining corresponding data, the list information is displayed using predetermined image data. As a result, content data is able to be displayed in a list without depending on a return format of list information from an external device. For example, in a case where the firmware of the external device is updated and the format of the list information is changed, a display mode is able to be changed accordingly. In addition, even in a case where the firmware of the external device is not updated, old formatted list information can also be displayed accordingly.

The list information can include a plurality pieces of cell information. The information processing apparatus can include a type determining portion or task configured to determine a type of cell information. The display controller changes an image to be displayed on the display portion according to a determination result of the type determining portion.

This configuration, by changing a display image according to a type of cell information, is able to display according to the format of the list information that has been obtained from the external device.

The type determining portion determines whether or not the cell information is hierarchical data. The display controller, in a case where the type determining portion determines that the cell information is hierarchical data, changes the image to be displayed on the display portion to an image informing of being hierarchical data.

In this configuration, a user can understand whether or not displayed list information is of a hierarchical type.

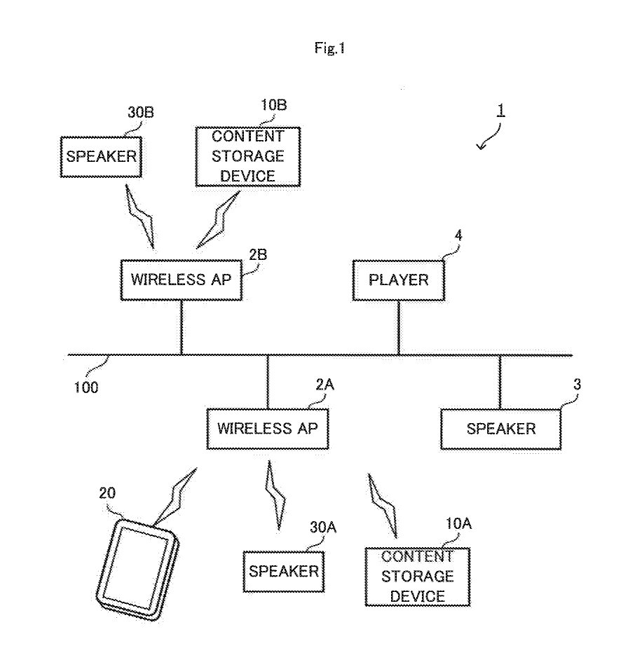

Referring to FIG. 1, which is a diagram illustrating a configuration of an audio system 1, the audio system 1 is provided with a wireless access point (hereinafter referred to as a wireless AP) 2A, a wireless AP 2B, a speaker 3, a player 4, and the like, that are connected to a wired LAN 100 wired in a building. Each of the devices, such as the wireless AP 2A and the wireless AP 2B, to be connected to the wired LAN 100 is arranged in a plurality of rooms, such as a living room or a bedroom in a building.

The wireless AP 2A and the wireless AP 2B construct a wireless LAN. The wireless AP 2A and the wireless AP 2B are connected to a content storage device 10A, a content storage device 10B, a portable terminal 20 that a user owns, a speaker 30A, a speaker 30B, and the like. In FIG. 1, the wireless AP 2A is connected to the portable terminal 20, the content storage device 10A, and the speaker 30A, and the wireless AP 2B is connected to the content storage device 10B, and the speaker 30B.

The content storage device 10A and the content storage device 10B output and input a wireless signal in accordance with standards, such as Wi-Fi (registered trademark) standards and Bluetooth (registered trademark) standard, and communicate with the wireless AP 2A, the wireless AP 2B, and the portable terminal 20. The content storage device 10A and the content storage device 10B have an HDD (Hard Disk Drive) or an SSD (Solid State Drive), for example, and store audio data. such as music data, or video data.

The content storage device 10A and the content storage device 10B are examples of an “external device.” Examples of the content storage devices include an information processing apparatus, such as a personal computer, a NAS (Network Attached Storage), or an AV receiver, for example. In addition, a content playing device, such as a CD player, is also included in the “external device.” The audio data is an example of the “content data.”

The content storage device 10A and the content storage device 10B distribute the audio data to the speaker 30A, the speaker 30B, the speaker 3, the player 4, or the like. The distributed audio data is played by the device of a distribution destination. It is to be noted that an audio device can be connected by wired or wireless communication to the content storage device 10A and the content storage device 10B, and audio data can be output to the audio device. In addition, the content storage device 10A and the content storage device 10B can be provided with a speaker, and audio data can be output from the content storage device 10A and the content storage device 10B.

The portable terminal 20 can be a smartphone, a tablet, a personal computer, or the like. The portable terminal 20 corresponds to an “information processing apparatus.” The portable terminal 20 can operate each device in a network. For example, the content of the audio data stored in the content storage device 10A (or the content storage device 10B) is displayed on the portable terminal 20. A user, by selecting the displayed audio data, can transmit the audio data from the content storage device 10A (or the content storage device 10B) to the speaker 30A, the speaker 30B, or the like.

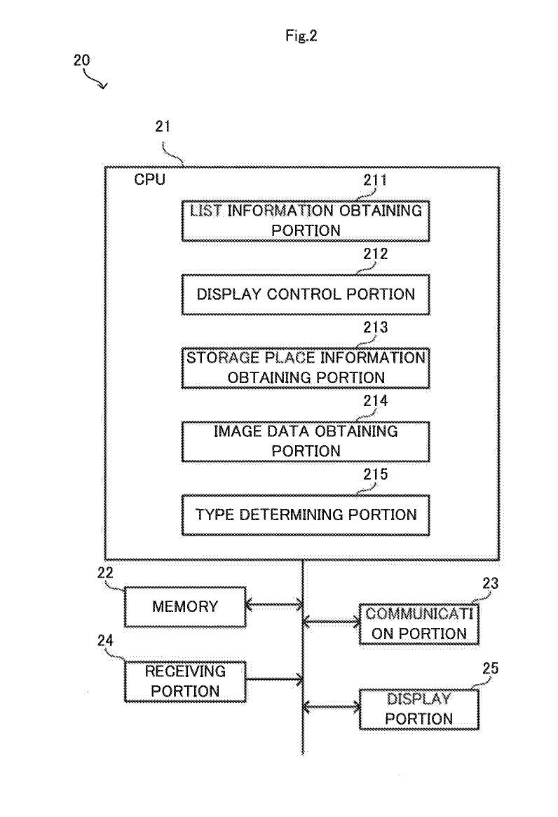

Referring to FIG. 2, which is a block diagram illustrating a configuration of the portable terminal 20, the portable terminal 20 is provided with a CPU 21, a memory 22, a communication portion (interface) 23, a receiving portion 24, and a display portion (display device) 25. The communication portion 23 outputs and inputs a wireless signal in accordance with standards, such as Wi-Fi (registered trademark) standards and Bluetooth (registered trademark) standard. By this communication portion 23, the portable terminal 20 is able to communicate with the wireless AP 2A, the wireless AP 2B, the content storage device 10A, and the content storage device 10B. The receiving portion 24 receives an operation by a user. The receiving portion 24 can be an operation button or a touch panel, which can be integrated with the display portion.

The memory 22 can include a RAM and a ROM. The memory 22 can store a program that the CPU 21 implements execute a plurality of tasks, a calculation processing result, information that the communication portion 23 receives, and the like.

The CPU 21 can read the program from the memory 22 and execute the read program. The CPU 21 is provided with a list information obtaining portion 211, a display controller 212, a storage place information obtaining portion 213, an image data obtaining portion 214, and a type determining portion 215. The “list information obtaining portion,” the “display controller,” the “storage place information obtaining portion,” the “image data obtaining portion,” and the “type determining portion” can be implemented by executing the program stored in the memory 22 by the CPU 21 to provide a plurality of corresponding tasks. The list information obtaining portion is an example of “the first obtaining portion.” The storage place information obtaining portion is an example of “the second obtaining portion.” The image data obtaining portion 214 is an example of “the third obtaining portion.”

To display the audio data stored in the content storage device 10A (or the content storage device 10B), the portable terminal 20 of this configuration makes a request to the content storage device 10A (or the content storage device 10B) for list information for creating a list screen, and receives the list information. Then, based on the received list information, the list screen is displayed on the display portion 25. As a result, a user can grasp the audio data stored in the content storage device 10A (or the content storage device 10B).

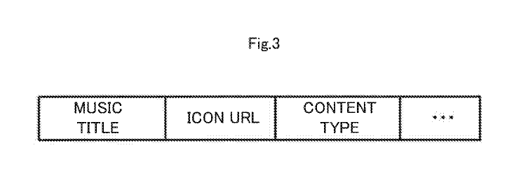

Referring to FIG. 3, which illustrates list information, the list information consists of a large number of pieces of cell information. Each piece of cell information includes a music name (title), an icon URL, content type information, and the like.

The content type information is information for identifying whether or not data corresponding to the cell information is hierarchical data. In a case where the cell information is hierarchical data, the data is “folder” information. In a case where the cell information is not hierarchical data, the data is “file” information. Even when the cell information is “file” information or “folder” information, the location of the data of the music data itself to be played is controlled by the content storage device 10A (or the content storage device 10B). The portable terminal 20 only sends a command and a request to “play what number of information” of a list to the content storage device 10A (or 10B). The same also applies in a case of making a request for play of the “folder” information. The information corresponding to the command and the request is again sent from the content storage device 10A (or the content storage device 10B) to the portable terminal 20.

The music name is a name of a “folder” or a “file” corresponding to the cell information, for example, an artist name, an album title, or a music piece title.

The icon URL is link information from which image data corresponding to the cell information can be obtained. The image data corresponding to the cell information can be an album jacket of an audio CD, image data of an artist, or the like, for example. A link destination is a server apparatus that stores image data, for example, and the server apparatus is provided mainly by a music organization. Image URL information is an example of “storage place information.”

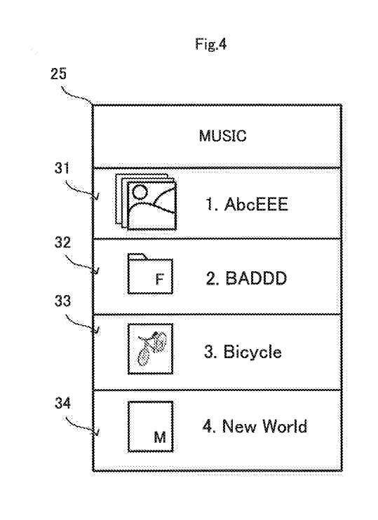

Referring to FIG. 4, which shows a list screen to be displayed on a display portion 25 based on received list information, the list screen can be displayed on the display portion 25 with an icon and a character. The character displayed at this time is information to be stored in a “music name” column of the cell information. In addition, the display mode of an icon can change with a type of cell information and a presence of obtained image data corresponding to the cell information.

In a case where the cell information is hierarchical data, and corresponding image data (an icon) has been obtained from image URL information, in a display region 31, the obtained image data is processed, superimposed icon image is created, and a character is also displayed. The obtained image data is displayed as an icon, so that a user can more easily grasp content (an album name, an artist name, and the like) corresponding to a cell. In addition, the image data is superimposed and displayed with an icon. The user, by selecting a displayed icon, also can visually grasp the fact that another data (lower layer data) is obtained (displayed).

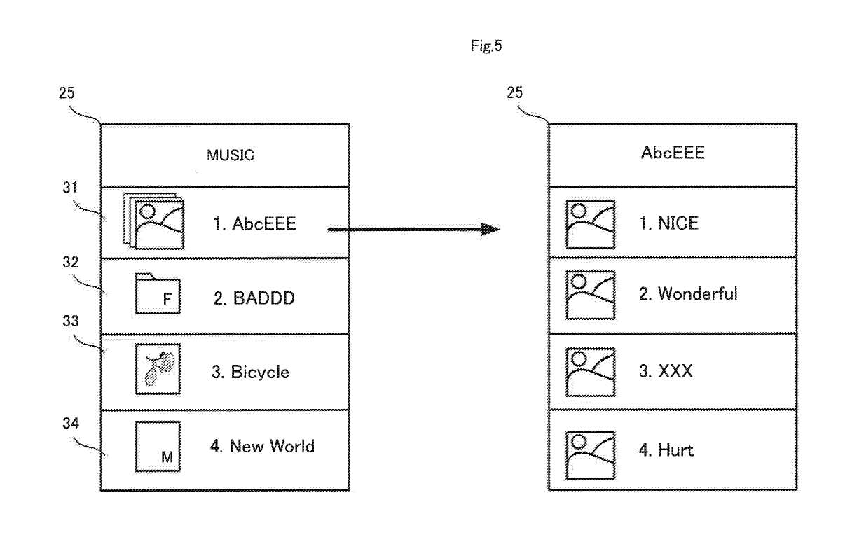

Referring to FIG. 5, which illustrates a display mode of the display portion 25 in a case where an icon of hierarchical data is selected, in a case where the icon (the display region 31 in FIG. 5) of hierarchical data is selected, a request to “play information corresponding to what number of cell of list information” is made from the portable terminal 20 to the content storage device 10A (or the content storage device 10B). As a result, in a case where the hierarchical data is “album” information, cell information of a music piece to be included in an album is received and a list screen is displayed based on the cell information.

Still referring to FIG. 5, in a case where the cell information is hierarchical data and corresponding image data is not able to be obtained from image URL information, an icon and character of predetermined image data are displayed in a display region 32. The predetermined image data is image data previously stored in the memory 22, for example. In addition, the situation where image data is not able to be obtained is a case where list information does not include image URL information or a case where image data is not registered on the URL.

In a case where the cell information is not hierarchical data and corresponding image data has been obtained from image URL information, in a display region 33, an icon and character of obtained image data are displayed. The obtained image data is displayed as an icon, so that a user easily grasps the content (a music piece title) of a cell visually. In a case where the cell information is not hierarchical data, and corresponding image data is not able to be obtained from image URL information, in a display region 34, an icon and character of predetermined image data are displayed. The predetermined image data displayed at this time is different from the predetermined image data in the case where the list information is hierarchical data.

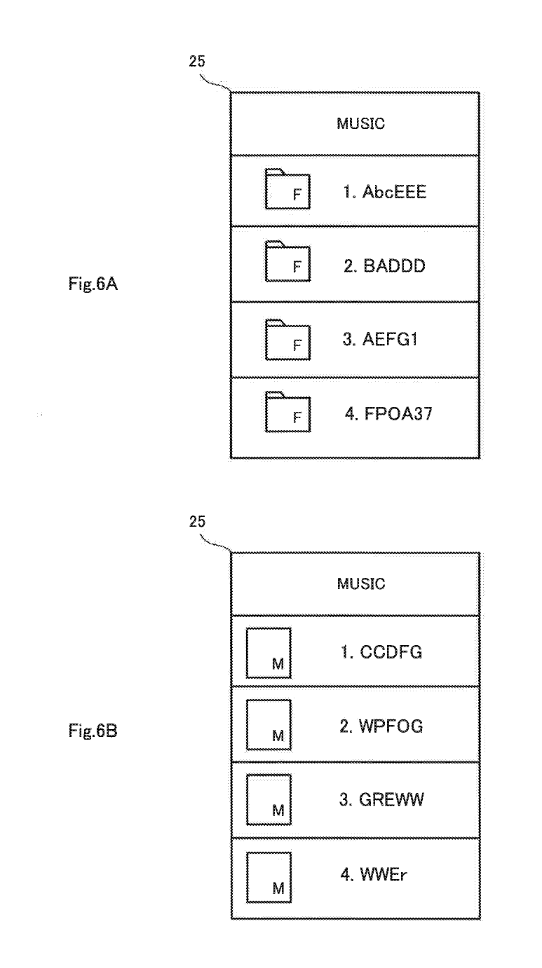

FIG. 6A and FIG. 6B illustrate another example of a list screen to be displayed on the display portion 25 based on received list information.

Depending on the content storage device 10A (or the content storage device 10B), availability of the firmware update, in reply to a request for list information of the portable terminal 20, the list information in an old style format, which does not have an icon URL region in cell information, still can be returned. In this case, since an icon URL is not able to be obtained in all the cell information, as illustrated in FIG. 6A and FIG. 6B, displays of each cell using an icon are all displays of predetermined images.

In this manner, by displaying different icons between the case where list information is hierarchical data and the case where list information is not hierarchical data, the user can more easily and visually grasps whether the displayed list information is information of music data (or video data) or whether the displayed list information is information of an album (or an artist). In particular, in the case where list information is hierarchical data, by creating an icon by superimposing image data and displaying the icon, the user can more easily and sensibly grasps the fact that the displayed list information is hierarchical data (information of an album or an artist).

Further, although the content storage device 10A (or the content storage device 10B) where the update of firmware has not completed can still return a list where an icon URL does not exist in the list information, by displaying an alternative image (a predetermined image) on the application side, a list corresponding to the version of the old and new firmware still can be displayed.

Hereinafter, a description will be made of a display process on a portable terminal 20 (an application).

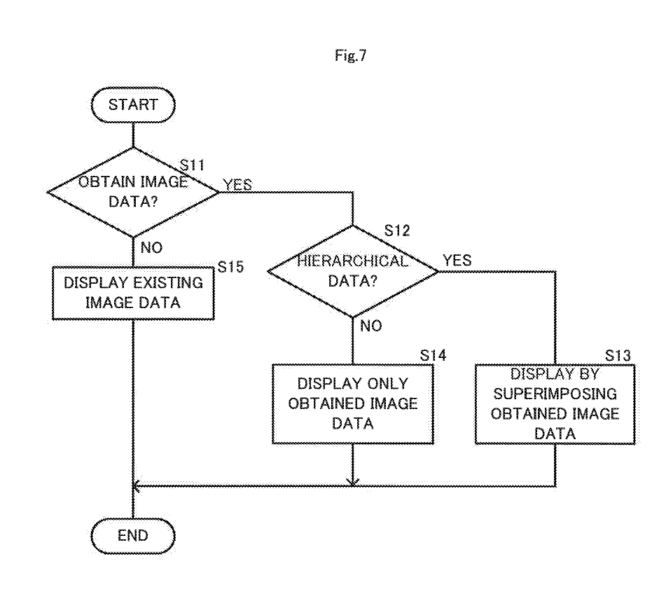

Referring to FIG. 7, which is a flow chart illustrating a process when the portable terminal 20 displays a list screen, when the list information received from the content storage device 10A (or the content storage device 10B) is displayed, the CPU 21 of the portable terminal 20 determines whether or not image data has been obtained based on the presence of icon URL information of cell information included in the list information or icon URL information (S11). When image data is obtained (S11: YES), the CPU 21 determines whether or not the cell information is hierarchical data from content type information (S12).

In a case where the cell information is hierarchical data (S12: YES) and the cell information is “folder” information, the CPU 21, as illustrated in the display region 31 of FIG. 5, creates an image by superimposing obtained image data and displays the image with a character (S13). In a case where the cell information is not hierarchical data (S13: NO), the CPU 21, as illustrated in the display region 33 of FIG. 5, displays only the obtained image data (S14).

In a case where image data is not obtained (S11: NO), the CPU 21 displays predetermined image data (S15). At this time, the CPU 21 displays different image data between the case where the cell information is hierarchical data and the case where the cell information is not hierarchical data.

The CPU 21 repeats the above process until the display process of the received list information is all completed.

It is to be noted that, in the case where the list information is hierarchical data, a display mode can only enable a user to understand the fact that the list information is hierarchical data, and the display mode can be appropriately changed. At least the display mode can be different from a display mode in the case where the list information is not hierarchical data. For example, obtained image data can be displayed by superimposing on (or aligning with) the predetermined image data displayed in the display region 32. In addition, in the display region 32, the predetermined image data can be superimposed and displayed. In addition, a user can select an icon to be displayed. For example, only an icon of hierarchical data can be displayed.

Given the present disclosure, one versed in the art would appreciate that there can be other embodiments and modifications within the scope and spirit of the present development. Accordingly, all modifications attainable by one versed in the art from the present disclosure within the scope and spirit of the present development are to be included as further embodiments of the present development. The scope of the present invention accordingly is to be defined as set forth in the appended claims.

What is claimed is:

1. An information processing apparatus comprising:
a first obtaining portion configured to obtain list information of content data that is playable by an external device;
a second obtaining portion configured to obtain storage place information of corresponding image data, based on the list information;
a third obtaining portion configured to obtain the image data based on the storage place information; and
a display controller configured to:
display a list screen using a predetermined image on a display portion, based on the list information; and
change the predetermined image based on the image data that the third obtaining portion obtains.

2. The information processing apparatus according to claim 1, wherein:
the list information includes a plurality pieces of cell information,
the information processing apparatus further comprises a type determining portion configured to determine a type of the cell information, and
the display controller changes an image to be displayed on the display portion according to a determination result of the type determining portion.

3. The information processing apparatus according to claim 2, wherein:
the type determining portion determines whether or not the cell information is hierarchical data, and
the display controller, in a case where the type determining portion determines that the cell information is hierarchical data, changes the image to be displayed on the display portion to an image informing indicative of hierarchical data.

4. The information processing apparatus according to claim 3, wherein the image indicative of hierarchical data includes a plurality of superimposed images.

5. The information processing apparatus according to claim 4, wherein the plurality of images include an image contained in the image data that the third obtaining portion obtains.

6. The information processing apparatus according to claim 5, wherein the plurality of images include the predetermined image.

7. The information processing apparatus according to claim 1, wherein the display controller:
in a case where the second obtaining portion is not able to obtain the storage place information, displays the predetermined image; and
in a case where the second obtaining portion has been able to obtain the storage place information, changes the predetermined image to the image contained in the image data that the third obtaining portion has obtained.

8. An information processing method comprising:
obtaining list information of content data that is playable by an external device;
displaying a list screen using a predetermined image on a display portion, based on the list information;
obtaining storage place information of corresponding image data, based on the list information;
obtaining image data based on the storage place information; and
changing the predetermined image based on obtained image data.

9. The information processing method according to claim 8, wherein:
the list information includes a plurality pieces of cell information, and
the information processing method further comprises:
determining a type of the cell information; and
changing an image to be displayed on the display portion according to a determination result of the type of the cell information.

10. The information processing method according to claim 9, further comprising:
determining whether or not the cell information is hierarchical data; and
changing the image to be displayed on the display portion to an image indicative of hierarchical data in a case where the cell information is determined to be hierarchical data.

11. The information processing method according to claim 10, wherein the image indicative of hierarchical data includes a plurality of superposed images.

12. The information processing method according to claim 11, wherein the plurality of images include an image contained in the obtained image data.

13. The information processing method according to claim 12, wherein the plurality of images include the predetermined image.

14. The information processing method according to claim 8, further comprising:
displaying the predetermined image as is, in a case where the storage place information has not been obtained; and
changing the predetermined image to the image contained in the obtained image data, in a case where the storage place information has been obtained.
